(19) United States
(12) Patent Application Publication
(10) Pub. No.: US 2013/0173523 A1
(43) Pub. Date: Jul. 4, 2013

(54) METHOD AND SYSTEM FOR CONTEXTUAL KNOWLEDGE SOCIETY NETWORK

(71) Applicants: Gerardo A. SANCHEZ, Boca Raton, FL (US); Alfredo E. SANCHEZ, Boca Raton, FL (US); Herman CAMARENA, Boca Raton, FL (US); Federico HERNANDEZ, Mexico City (MX); Antonio NUÑO, Mexico City (MX); Carlos Del CASTILLO, Boca Raton, FL (US)

(72) Inventors: Gerardo A. SANCHEZ, Boca Raton, FL (US); Alfredo E. SANCHEZ, Boca Raton, FL (US); Herman CAMARENA, Boca Raton, FL (US); Federico HERNANDEZ, Mexico City (MX); Antonio NUÑO, Mexico City (MX); Carlos Del CASTILLO, Boca Raton, FL (US)

(73) Assignee: SPRIBO, LLC., Boca Raton, FL (US)

(21) Appl. No.: 13/339,789

(22) Filed: Dec. 29, 2011

(51) Int. Cl. G06N 5/02

(52) U.S. Cl. 706/50; 706/55

(57) ABSTRACT

Aspects of the disclosure can provide a system that includes a knowledge model configured to represent a knowledge society entity with a specific context, a semantic engine, and a plurality of processors. The processors are configured to implement software instructions that instruct the semantic engine to operate a contextual knowledge society network according to the knowledge model. The knowledge model is configured to semantically represent elements and links of the elements under the specific context.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Information technology (IT) generates, accumulates and manages knowledge. In an example, based on needs of an IT application, IT personnel normalize related knowledge and store the normalized knowledge in a database or spreadsheet. The database or the spreadsheet can be accumulated, managed and manipulated according to the needs of the IT application. However, when the IT application adds new features or when a new IT application is based in part on the related knowledge, the database or the spreadsheet may need to be migrated to a new version to suit for the new features or the new needs of the new IT application. Generally, the migration requires significant technical support, manpower and is time consuming.

### SUMMARY

A Knowledge Society (KS) is one that offers capabilities to identify, produce, transform, process, analyze, evaluate, and disseminate information to create, share, and apply knowledge for innovation, human development and the prosperity and well-being of its people. A Knowledge Society Entity (KSEn) offers these capabilities to a select group of people. A Knowledge Society Ecosystem (KSEco) integrates multiple Knowledge Society Entities. A Knowledge Society may be formed by one Knowledge Society Ecosystem or a plurality of Knowledge Society Ecosystems.

Currently, Web 1.0, simply known as the web, operates based on a one-way flow of information by publishing ‘read-only’ content and applications on a web site. Web 2.0, also known as the Social Web, is a vision of the web in which simple tools are available for everyone to participate. Looking forward, Web 3.0, also known as the Semantic Web, aims at the concept of linked data by proposing more intelligent ways to represent and communicate knowledge and provides a framework to interact with ubiquitous sources of information. Based on the Web 2.0 and Web 3.0 concepts, a knowledge network is an online social ecosystem where a group of people with common interests, purposes, values or beliefs can connect, collaborate, create, consume, and share information, contacts, and experience around a professional or social specific context, interpreting the meaning of these data as the key element to understand, direct, and control better their social media presence and interact in more relevant, precise, useful, productive and enjoyable ways.

Aspects of the disclosure provide a system that includes a network, a semantic engine, a knowledge model and software applications to create and manage a Contextual Knowledge Society Network (CKSNet). Specifically, the system enables a stakeholder who acts as a knowledge network domain expert (the CKSNet creator), to classify and organize information about other stakeholders who become knowledge network members when they join the CKSNet (the CKSNet members), as well as things (any kind of related concepts), applications, and dispersed content available over the network around a specific context. The system can be hosted on a network infrastructure platform that provides a web site location that can be accessed through cloud services over the Internet.

CKSNet creators can create a knowledge-empowered online community (a knowledge society entity) from a web site location. The knowledge-empowered online community defines specific purposes. Stakeholders of the knowledge-empowered online community are linked to the KSEn context. A social graph ontology can be used by the system to represent KSEn members and domain ontology extensions to classify and link purposes, concepts, and stakeholders under the KSEn context. The CKSNet system provides ontology editing tools to define, extend or modify KSEn stakeholders, attributes of stakeholders, things, attributes of things, associations among stakeholders and things to refine a knowledge model that conforms to the context, concepts, purposes and stakeholders defined by the CKSNet creator. An agnostic ontology-driven semantic engine application can be used to implement a knowledge representation method and generate a knowledge base that is populated using CKSNet tools with knowledge instances produced by the CKSNet creator and those KSEn stakeholders who are granted controlled access to the CKSNet by the CKSNet creator. An ontology link and visualization framework and method can generate Graphical User Interfaces for applications that use the knowledge base, enabling the CKSNet creator and those CKSNet members who are granted controlled access to the CKSNet by the CKSNet creator to visualize, populate and/or query specific instances of the CKSNet knowledge base.

Communication techniques can be used to enable target-audience interaction among KSEn stakeholders, trigger “smart actions” associated with CKSNet applications, and generate “smart views” of information by using semantic query and inference processes that apply to the CKSNet knowledge base. The CKSNet system can provide “smart applications” that reuse metadata, associations, and other semantic constructs defined in its knowledge model and apply “smart lists”, “smart views”, and “smart actions” generated by CKSNet creators, as well as by CKSNet members who are granted controlled access to such applications as CKSNet members by the CKSNet creator through the definition of rules and semantic constraints. An observation application and techniques can be used to observe CKSNet members' behavior and populate CKSNet member attribute instances. An extensible aggregation framework and a “Navigable Web Content Finder” method can enable CKSNet member to securely link their computer-implemented social network accounts, aggregate information, including content of computer-implemented social networks, databases and other content from the web, import and extend aggregated content attributes, and link this information to the CKSNet knowledge base to interact, direct and reuse it under the specific context and purposes of the KSEn. A push application and a method can monitor instances of the CKSNet knowledge base related to one or more CKSNet members and the associations that one or more CKSNet members have among them, and apply query, constraint and other semantic capabilities acting on the CKSNet knowledge base to push messages, recommendations, alerts, and promotional advertisements to a target CKSNet member audience. A CKSNet Operations Administration and Management framework may provide tools to the CKSNet creator or to those administrators who are granted controlled administration privileges by the CKSNet creator to manage and control the CKSNet. An integration method that uses semantic merge capabilities can aggregate multiple CKSNet's into one Contextual Knowledge Society Network Ecosystem (CKSNEco) to integrate multiple KSEn's into one KSEco.

A high-concurrency framework can be included to create highly scalable programs optimized to run on modern multi-core processors to respond to a plurality of concurrent transactions from a plurality of a CKSNet members, defining Tasks, Processing Queues, I/O Handlers, I/O Processors, Actors and Timers abstractions aimed at achieving cost-effective escalation for a very high volume of computer transactions generated by the CKSNet and the CKSNEco. The system can include knowledge marketing (k-marketing) techniques that provide effective marketing campaigns based on CKSNet member behavior, to design and direct effective marketing campaigns to CKSNet and CKSNEco members pushing recommendations and promotional advertisements generated by constraints applied to the knowledge base, and to measure marketing campaign effectiveness. A knowledge commerce (k-commerce) system and method can be included to reuse the CKSNet and CKSNEco extensible aggregation framework and allow the CKSNet and CKSNEco to interact with e-commerce sites and social networks, providing recommendations based on constrains applied to the CKSNet and CKSNEco knowledge base to empower buyer and seller stakeholders to make better decisions on buying and selling goods and on creating virtual productive value chains. A knowledge gamification (k-gamification) method can also be included to design network member loyalty strategies based on CKSNet member behavior on the CKSNet, that enable CKSNet creators to attract new network members and retain existing CKSNet members on the CKSNet and on the CKSNEco by means of using gamification applications information to populate instances of the knowledge base and apply query and constraints to create “smart lists” that can be used by CKSNet applications.

Aspects of the disclosure can provide a system that includes a knowledge model configured to represent a KSEn with a specific context, a semantic engine, and a plurality of processors. The processors are configured to implement software instructions that instruct the semantic engine to operate a CKSNet according to the knowledge model. The knowledge model is configured to semantically represent elements and links of the elements under the specific context.

In an embodiment, the processors generate a graphical user interface that is configured to enable a CKSNet creator to modify the knowledge model using the semantic engine.

In another embodiment, the processors generate a graphical user interface that is configured to enable CKSNet members to cause the semantic engine to access the CKSNet, populate instances of concepts in the CKSNet and/or extract specific knowledge from the CKSNet.

According to an aspect of the disclosure, the processors are configured to process a plurality of access operations to a knowledge base of the CKSNet in a single semantic transaction. Further, the controller is configured to process a plurality of semantic transactions concurrently.

Further, in an embodiment, the processors are configured to generate a graphical user interface that is configured to navigate, view and select contents scattered in various web sites.

In an embodiment, the system includes a first memory configured to store a knowledge base of the CKSNet according to the knowledge model, and a second memory configured to store information for generating the knowledge base. In an example, the second memory is non-volatile memory.

According to an embodiment of the disclosure, the semantic engine is configured to operate on a topic map of the CKSNet generated based on the knowledge model.

Aspects of the disclosure also provide a method of providing a CKSNet. The method includes determining a knowledge model to represent a KSEn with a specific context, utilizing a semantic engine to create a CKSNet according to the knowledge model, and utilizing the semantic engine to manage the CKSNet according to the knowledge model.

Further, in an embodiment, the method can include providing a graphical user interface that enables a network creator of the CKSNet to define and update the knowledge model using the semantic engine. In addition, the method includes providing a graphical user interface that enables network members of the CKSNet to access the CKSNet to populate instances of concepts in the CKSNet and to extract specific knowledge from CKSNet using the semantic engine.

According to an aspect of the disclosure, the method includes using the semantic engine to process a plurality of access operations to a knowledge base of the CKSNet in a single transaction. Further, the method includes using the semantic engine to process a plurality of transactions concurrently.

Aspects of the disclosure also provide a non-transitory storage medium storing program instructions for causing a processor to execute operations for providing the CKSNet.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows an exemplary block diagram of a system 100 according to an embodiment of the disclosure;

FIG. 2 shows an exemplary block diagram of a knowledge network service provider 250 according to an embodiment of the disclosure;

FIG. 3 shows an exemplary block diagram of a semantic development platform 300 according to an embodiment of the disclosure;

FIG. 4 shows a flow chart outlining an exemplary process example for a network creator to use the semantic development platform 300 to create and manage a CKSNet according to an embodiment of the disclosure;

FIG. 5 shows a diagram of an exemplary CKSNet architecture according to an embodiment of the disclosure;

FIG. 6 shows an exemplary plot of a network member apparatus according to an embodiment of the disclosure;

FIGS. 7A-7D show examples of task based programming for increasing concurrency in a semantic development framework according to an embodiment of the disclosure;

FIGS. 8A-8C show examples of processing queue programming for increasing concurrency in a semantic development framework according to an embodiment of the disclosure; and

FIG. 9 shows a plot of a graphical user interface example 900 of an application according to an embodiment of the disclosure.

### DETAILED DESCRIPTION OF EMBODIMENTS

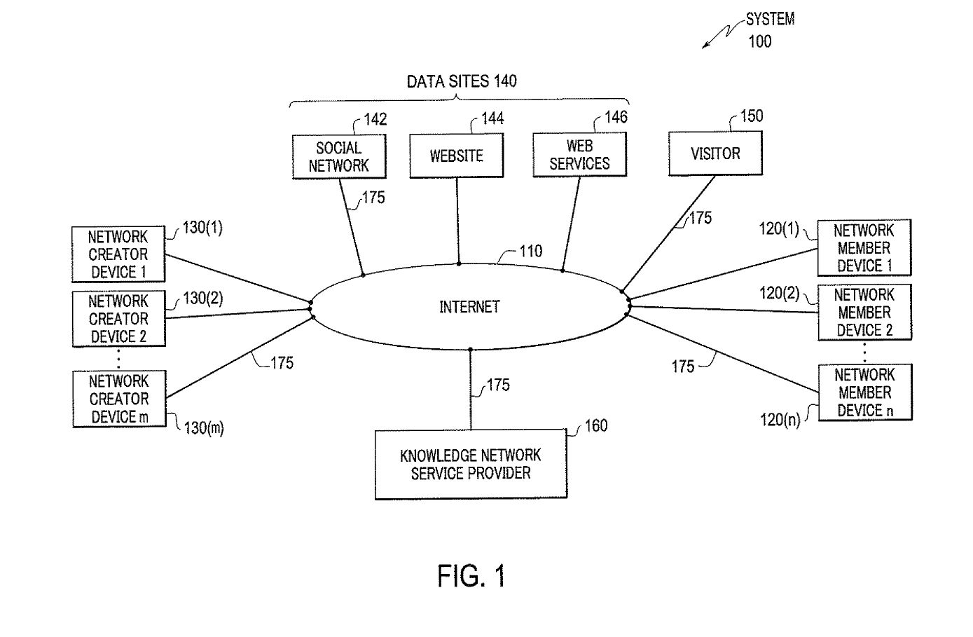

FIG. 1 is a block diagram of an exemplary system 100 according to an embodiment of the disclosure. The system 100 is configured to establish one or more CKSNets where each CKSNet integrates knowledge distributed in system 100 around a specific context. As shown, the system 100 can include multiple network member devices 120(1) to 120(n), network creator devices 130(1) to 130(m), and data sites 140 that are coupled to the Internet 110 via communication links 175 (m and n are positive integers). The system 100 also includes a knowledge network service provider 160 that can be coupled to the Internet 110 via a communication link 175. Additionally, the system 100 may also include one or more visitor 150 that can also be coupled to the Internet 110 via a communication link 175.

The network member devices 120(1) to 120(n) can be devices of any type that permit a network member to communicate with the knowledge network service provider 160 via the Internet 110, and thus enable network members to participate into one or more CKSNets. For example, the network member devices 120(1) to 120(n) can be a desktop computer, a laptop computer, a tablet device, a mobile phone device, personal digital assistant (PDA), smart phone, videophone, video conference application, smart or computer-assisted TV, and the like. For purposes of the following description of the invention, it will be assumed that the network member devices 121-120n are personal computers.

The data sites 140 include any collection of data or information that can be integrated into a CKSNet. As shown, the data sites 140 can include social networks 142. Generally, a social network 142 is any Web 2.0 online service that focuses on building social relationships among people who share interests and/or activities. Examples of social networks 140 include Facebook, Twitter, Linked-In, and the like.

Other data sites 140 include websites 144 and web services 146. The websites 144 can include any collection of web pages having images, videos, or other digital assets that are accessible via a network. Currently, millions of websites are available to Internet users. The web services 146 can include any service that is provided via a network to a user. Web services 146 can be used, for example, to facilitate online transactions, such as the PayPal web service that facilitates on-line purchasing.

The network creator devices 130(1) to 130(m) can be devices of any type that allow a network creator to communicate with the knowledge network service provider 160. For example, the network creator devices 130(1) to 130(m) can be a desktop computer, a laptop computer, a tablet device, a mobile phone device, personal digital assistant (PDA), smart phone, videophone, video conference application, smart or computer-assisted TV, and the like. For purposes of the following description, it will be assumed that the network creator devices 130(1) to 130(m) are personal computers.

The network member devices 120(1) to 120(n), network creator devices 130(1) to 130(m), data sites 140, visitor 150 and knowledge network service provider 160 are in communication with the Internet 110 over communication links 175. These communication links 175 may be any type of wired and/or wireless connection that allows for the transmission of information. Some examples include conventional telephone lines, fiber optic lines, direct serial connections, cellular telephone connections, satellite communication links, local area networks (LANs), Internets, and the like.

While the Internet 110 is generally known as a global system interconnected computer network that serves billions of users worldwide, it should also be understood that for purposes of this disclosure the Internet may be a single network or a plurality of networks of the same or different types. For example, the Internet 110 may be a data network or a telecommunications or video distribution (e.g., cable, terrestrial broadcasts, or satellite) network in connection with a data network. Any combination of telecommunications, video/audio distribution and data networks, whether a global, national, regional, wide-area, local area, or in-home network, may be used without departing from the spirit and scope of the invention.

The knowledge network service provider 160 provides a semantic development platform. The semantic development platform facilitates creation and operation of one ore more CKSNets.

As shown, the knowledge network service provider 160 may be an independent unit coupled to the Internet 110, or it may include devices distributed at various locations and coupled together via a network, such as a local area network (LAN), the Internet 110, and the like. For example, the knowledge network service provider 160 may be made part of the various central offices or servers (not shown) employed by the Internet 110, which are distributed throughout the Internet 110. Any configuration and architecture that permit the knowledge network service provider 160 to provide knowledge network service can be used without departing from the spirit and scope of the invention.

According to an aspect of the disclosure, the system 100 enables the knowledge network service provider 160 to provide a semantic development platform to facilitate creation and operation of one or more CKSNets. According to an embodiment of the disclosure, based on the system 100, a network creator can use one or more of the network creator devices 120 to access the semantic development platform provided by the knowledge network service provider 160 to create a CKSNet. Further, the semantic development platform assists the network creator to engage network members to participate in the CKSNet. The participation of the network members populates the content of the CKSNet. Further, the semantic development platform enables the network creator to visualize the CKSNet, to maintain the CKSNet, to analyze the CKSNet, to update attributes of the CKSNet, to add features to existing applications of the CKSNet, and to create new applications based on the CKSNet. The applications based on the CKSNet provide various society information and various society services to the network members.

An example of operation of the system 100 will now be described. In an example, based on the system 100, a person or an entity interested in a baseball team signs up for the service provided by the knowledge network service provider 160 and becomes a network creator. The knowledge network service provider 160 assists the network creator to create a baseball knowledge society network based on the semantic development platform, and assists the network creator to manage the baseball knowledge society network based on the semantic development platform.

For example, the knowledge network service provider 160 assists the network creator to initiate an instance of a knowledge network based on the semantic development platform, such that the knowledge network is suitably coupled to the various parts, such as a semantic engine, a database, a portal, virtual machine, and the like of the knowledge network service provider 160. In an example, the knowledge network includes a knowledge model, and a knowledge base built on the knowledge model. The knowledge network service provider 160 provides the semantic development platform to control the operation of the knowledge network.

Further, the knowledge network service provider 160 assists the network creator to configure attributes of the knowledge network, such as community information, web pages, appearance, privacy and security, media integration, applications, and the like. As part of this assistance, the network creator can define, modify and publish the online terms and conditions that visitors who want to sign up to the CKSNet need commit to comply by accepting them.

For example, the knowledge network service provider 160 can also assist the network creator to contextualize the knowledge network according to the baseball club interest to form a CKSNet. In an embodiment, the network creator expands the knowledge model according to the baseball team interest. For example, the network creator can add member profile extended attributes to the knowledge model, such as a role in a team, fans of a team, and the like. In another example, the network creator can add members relationship extended models to the knowledge model, such as coach of the team, teammate, and the like. In another example, the network creator may add knowledge network extended concepts, such as baseball team history milestones, supply information, court information, and the like.

Additionally, the knowledge network service provider 160 assists the network creator to engage network members to participate in the CKSNet. In an embodiment, based on the semantic development platform, the network creator can publish web content, broadcast messages, generate advertisements, alerts and recommendations, aggregate information from social media, and the like. In an example, a network member joins the CKSNet in response to a broadcast message.

When the network member joins the CKSNet, the network member accepts the terms and conditions published by the knowledge network service provider 160 and the network creator, and provides information according to, for example, a questionnaire on a webpage generated by the network creator based on the semantic development platform. Based on the provided information, a member instance can be created according to the knowledge model. The member instance is suitably added into the knowledge base. The network member can share the same network member account basic information created in one CKSNet with another CKSNet or with a plurality of CKSNets hosted by a common knowledge network service provider. In an example, when an existing network member of a first CKSNet wants to join a second CKSNet and is approved by the network creator and/or by the membership policies of the second CKSNet. The network member of the first CKSNet can enter the additional member profile information as required by the second CKSNet, and can accept the terms and conditions established by the network creator of the second CKSNet in order to become a network member of the second CKSNet.

Subsequently, the knowledge network service provider 160 may assist the network creator to manage the CKSNet. In an example, the network creator can manage applications based on the CKSNet, such as adding new features, generating new applications and the like. In another example, the network creator can perform members' administrations, such as assign control right, block access, and the like. In another example, the network creator can perform analytics of the CKSNet.

It is noted that the network creator may generate applications from various business concepts based on the same knowledge base generated by the CKSNet. For example, the network creator can query the knowledge base for one or more people, concepts, things, and the like attributes and generate “smart lists” of people, concepts, things, and the like that match those attributes. In another example, the network creator can constrain the knowledge base, and generate a subset of the knowledge base. The subset can be queried and visualized by the network creator. In another example, the network creator may take “smart actions” based on the knowledge base. For example, based on the knowledge base, the network creator can generate messages, recommendations, alerts, and promotional advertisement to portions of the network members, such as fans of a baseball team.

According to another aspect of the disclosure, based on the knowledge base, various business applications, such as a knowledge marketing (k-marketing) application, a knowledge commerce (k-commerce) application, a knowledge gamification (k-gamification) application, and the like, can be used or generated.

For example, a k-marketing application can be generated based on the knowledge base. In the k-marketing application, constraints are applied to the knowledge base to filter network members based on their behaviors, Then, marketing campaign, such as recommendations, promotional advertisements, and the like, can be generated to target the filtered network members. Further, effectiveness of the marketing campaign can be measured based on the knowledge base.

For example, based on the semantic capability, understandings of how different concepts of the knowledge base are related (e.g., distribution of knowledge resources; behavioral and semantic targeting identifying related concepts and the context of the CKSNet member interaction to increase the effectiveness of brand penetration and marketing campaigns directed to a specific audience; knowledge-based interaction with social networks as a powerful marketing technique; semantically classified feedback on branding and product/service perception based on the CKSNet member behavior and semantic analysis of social network content and benchmarking; measurement of contextual marketing campaign impacts based on knowledge base constraints; etc.) can be achieved. Based on the understanding, marketing activities can be determined.

In another example, a k-commerce application can be generated based on the knowledge base. In the k-commerce application, the CKSNet may include e-commerce extensible aggregation framework to allow the CKSNet to interact with e-commerce sites and social networks, providing recommendations based on constrains applied to the knowledge base of the CKSNet and e-commerce extensible aggregation framework to empower buyer and seller network members to make better decisions on buying and selling goods and on creating virtual productive value chains to bundle combined commercial offerings.

For example, based on the semantic capabilities of the CKSNet to exchange tacit and explicit knowledge about products and services and compile relevant information generated as a result of the participation of the online community and semantic processes of the CKSNet, such as query and constraints, applied to the knowledge base, CKSNet members are enabled to make better trade decisions (e.g., knowledge-based product offerings; knowledge-based product configuration, bundling and pricing; finding the most appropriate product/service options under a specific context based on applying constraints to the knowledge base; identifying partners in productive chains to package knowledge, product, service and value offerings; knowledge exchange of virtual productive chain forming a KSEn or a KSEco; etc.)

In another example, a CKSNet application can be generated to interact with a k-gamification application to integrate the information generated by the k-gamification application to the knowledge base, on which queries and constraints can be applied to the knowledge base to create “smart lists” that can be used by CKSNet applications, For example, to design loyalty strategies, retain CKSNet members, recommend CKSNet connections, push ads, alerts, recommendations, and the like. Based on the results of the queries and constraints, member loyalty strategies can be designed to retain existing network members and attract other stakeholders to become network members.

For example, based on the semantic capabilities of the CKSNet, activities aimed at achieving a desired progress within a KSEn via contextual simulation combined with other elements focused on a chance to win specific tangible things such as discounts, cash, products, trips, reward points, and the like or intangible things such as reputation, recognition, diploma, badges, and the like can be directed. Further, proper incentives for the CKSNet members to contribute, and to provide an engaging, self-reinforcing experience under a context in which to motivate the CKSNet members to participate in activities related to the various purposes of the KSEn such as loyalty programs based on points earned by populating instances of the knowledge base, encouraging CKSNet members to engage in behavior objectives through inference processes based on incremental progress made in the past guided by semantic constraints, motivation campaigns to participate in activities considered by members of the CKSNet as boring but relevant for the KSEn purposes using semantic alerts and reward points, adding sustainability elements to a KSEn on member's contribution to a clean environment that can be semantically mapped to obtain rewards, and the like can be created.

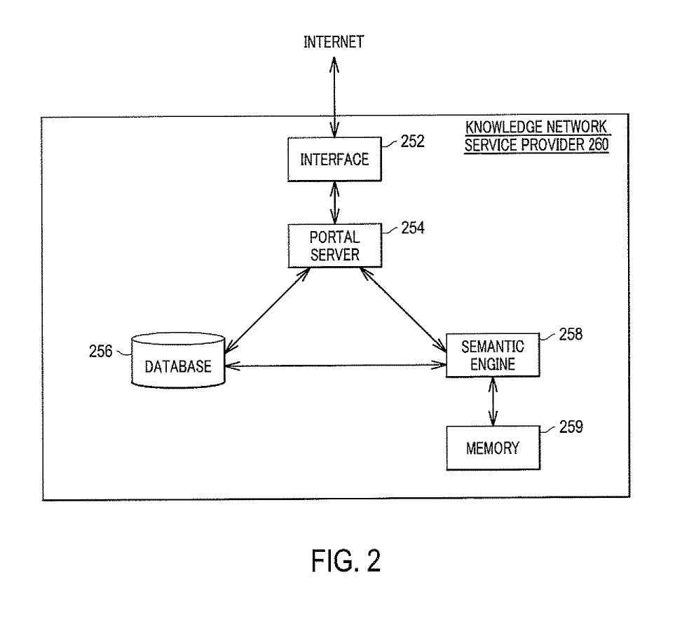

FIG. 2 shows an exemplary block diagram of a knowledge network service provider 260 according to an embodiment of the disclosure. The knowledge network service provider 260 corresponds to the knowledge network service provider 160 shown in FIG. 1, however it includes more detail as to a possible configuration. The knowledge network service provider 260 includes an interface 252, a portal server 254, a semantic engine 258, a memory 259, and a database 256. These elements are coupled together as shown in FIG. 2.

The interface 252 is configured to enable the knowledge network service provider 260 to communicate with network creators, network members, visitors and data sites via the Internet, and provide respective knowledge network service to the network creators, the network members and the visitor. In an example, the interface 252 can include web servers (not shown) and mobile applications (not shown). The web servers can enable communication via web pages, while the mobile applications enable communication via mobile devices.

According to an aspect of the disclosure, the interface 252 provides a graphical user interface framework to the knowledge network service provider 260 and to the network creator to use applications that present a graphical user interface on the access device to display, push, query, and populate instances of the knowledge base using various graphical formats such as page layouts, appearance templates, Web forms, content portlets, application portlets, widgets, photo albums, video channels, and the like. Further, the interface 252 extends the graphical user interface framework to various mobile devices, to operate CKSNet mobile applications and apply instance population, query and constraint processes to the CKSNet knowledge base through the mobile devices. In an example, the interface 252 includes, an application that provides a user interface to access content managed and stored in different sites or services, exposed through an API on the Web or what is known as “The Cloud” (typically using a REST architecture), acting as a “navigable Web content manager.” Such application can be referred to as, or for example, “Navigable Web Content Finder”. Similar to the way a user can set different storage devices in an operating system, with “Navigable Web Content Finder” CKSNet network creators and CKSNet network members can add different Web content providers (e.g., YouTube, Flickr, Blogger or Facebook). It should be understood that any site that exposes Web content through an API can be a content provider. When a network creator or a network member runs an aggregation process, he authorizes “Navigable Web Content Finder” as a reliable source in various content sites and social media. The aggregated content may be used by applications in the CKSNet. In an embodiment, the “Navigable Web Content Finder” facilitates the access, visualization, aggregation of external multimedia resources and navigation of contents from a central location, so that semantic applications can integrate the contents as instances of the CKSNet knowledge base under a specific context (e.g., videos or photographs related to a certain product or person).

The portal server 254 may serve as a point of access to the CKSNet service. The portal server 254 can be a single server or a plurality of servers coupled in a unified or a distributed manner. In an embodiment, the portal server 254 implements an identity based access policy and user authorization and user authentication methods based on security protocols and standards such as SAML, OAuth, OpenId and the like, to improve privacy and security features.

The semantic engine 258 is configured to process a knowledge base based on a semantic technology. The semantic engine 258 can include a single processor executing software instructions or a plurality of processors coupled in a unified or a distributed manner or even a virtual machine or a plurality of virtual machines running on a single processor or a plurality of processors. According to an embodiment of the disclosure, the semantic engine 258 is implemented based on a high concurrency framework.

Further, according to an embodiment of the disclosure, the semantic engine 258 is configured to support transactions in the knowledge base. In an example, a series of changes to the knowledge base are grouped in a list and sent to the semantic engine 258 for processing. The semantic engine 258 is configured to handle the series of changes to the knowledge base in a single transaction. Thus, when the single transaction is successfully handled, all the changes in the single transaction are applied to the knowledge base; and if anything happens and causes the single transaction to fail, none of the changes are applied to the knowledge base, the result of the transaction is reported to the semantic engine 258 application. The semantic engine 258 application can decide to modify some of the operations according to the error and retry if appropriate. Thus, the transaction based knowledge base processing can reduce uncertainty of the knowledge base due to unpredictable events.

The memory 259 is configured to store one or more knowledge bases. The memory 259 can be a single memory or a plurality of memories coupled together in a unified or distributed manner. In an example, the memory 259 includes random access memory that can be accessed with relatively high speed. In an embodiment, the knowledge bases are stored in the form of topic maps. The topic maps can be stored in accordance with any known or later developed topic map standard.

The database 256 is configured to log all the information for generating and updating one or more knowledge bases. In an embodiment, the database 256 is stored in a non-volatile memory that maintains stored data in response to a power failure, and the memory 259 is volatile memory that loses stored data in response to a power failure. In the event of a power failure, the non-volatile memory can retain the stored data for generating and updating the knowledge base, even though the memory 259 may lose the stored knowledge base. When power returns, the knowledge base can be re-created and recovered in the memory 259 based on the data in the database 256.

During operation, for example, when the portal server 254 receives any access request to the knowledge base, the access request information is provided to both the database 256 to log the access request information, and the semantic engine 258 to process the knowledge base stored in the memory 259 based on the semantic technology. In an embodiment, the semantic engine 258 groups a plurality of access operations to the knowledge base in a single transaction, and performs transaction based knowledge base processing.

In another embodiment, the portal server 254 accesses the knowledge base to read data, requesting this data to the semantic engine 258; if this data is already stored in memory 259 (cache) it is delivered to the portal server 254; if this data is not stored in memory 259, the semantic engine 258 requests it to the database 256 and stores it in memory 259 for future access.

In another embodiment, when the portal server 254 requests changes to the knowledge base such as add, modify, delete and the like, the semantic engine 258 receives all these changes as a single transaction and performs a transaction based update to the database 256; if successful, it distributes all changes to a plurality of memory 259 nodes to keep them updated.

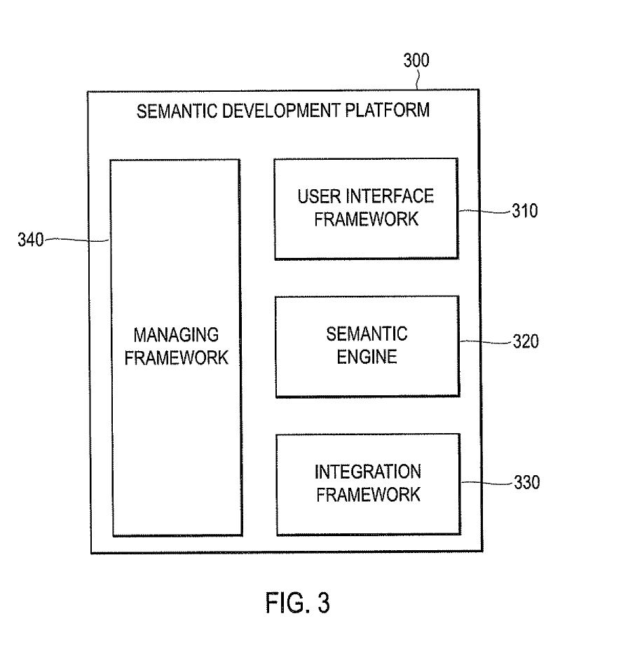

FIG. 3 shows an exemplary block diagram of a semantic development platform 300 according to an embodiment of the disclosure. In an example, the knowledge network service provider 160 provides the semantic development platform 300 to enable creation and operation of a CKSNet.

According to an aspect of the disclosure, the semantic development platform 300 includes a semantic engine 320 configured to process a knowledge base of the CKSNet based on a semantic technology, such as a topic map standard, and the like. According to an aspect of the disclosure, a semantic technology represents knowledge in a knowledge base using a knowledge model that closely reflects the real world. This knowledge base is substantially independent of the needs of an application. Therefore, new development, such as new features of the same application, or new application based on the knowledge model can exploit the knowledge base without major reengineering efforts.

In an embodiment, the knowledge base stores the CKSNet in the form of a topic map. The topic map can be created and stored according to a topic map standard, such as the topic map standard defined in ISO 13250, which is incorporated herein by reference in its entirety. A topic map is built using three basic semantic constructs: topics, associations, and occurrences. A topic can be any “thing”, such as a person, an entity, a concept, and the like. An association asserts a relationship between two or more topics. The association also defines individual roles of the topics in the association, and the nature of the association. An occurrence is an information resource, such as a news web site, a video sites, a photo site, and the like, that is linked to an instance of the topic. In an example, the occurrence can be used to address information that is stored outside of the topic map.

Further, in an embodiment, the topic map supports various semantic operations, such as definition, merging, query, constraint, and the like. In a definition operation, attributes of a topic, an association, or an occurrence can be defined. In a merging operation, two topic maps representing two different knowledge models of individual CKSNets or a plurality of topic maps representing a plurality of knowledge models of individual CKSNets can be merged together to create one CKSNEco. The CKSNEco integrates common and independent members, attributes of members, things, attributes of things, associations among members and things of each individual CKSNets, common associations across all CKSNets and unique associations to network members and things as defined in individual CKSNets into a single topic map. The merge process simplifies the integration, aggregation and enrichment of the knowledge stored in the resulting topic map. The single topic map represents one aggregated knowledge model of the CKSNEco with a larger context defined by the KSEco. For example, it can generate one aggregated knowledge base, making the CKSNEco available to all members of each individual CKSNet that forms part of the CKSNEco under a richer context, allowing interaction between CKSNet members of all individual CKSNets that form part of it under the new context to exchange target content generated across all individual CKSNets that form part of it directed to wider target audiences of the CKSNEco.

Further, in a query operation, the topic map is searched to generate an answer list of things that satisfy the query. The query process provides a very intuitive way to access and navigate the knowledge base. For example, a CKSNet creator or a CKSNet member defines certain CKSNet member attributes such as where they live, interests, profession, and the like. The query can be saved as a “smart list”. When the smart list is evaluated it will find all elements that comply with those attributes. In an example, a smart list may result in X, Y, Z network members of the CKSNet to push a specific message on the welcome Web 3.0 when they sign in to the CKSNet. In a constraint operation, a network creator can define the characteristics that a particular knowledge society network should meet. The constraint process allows to specify a set of rules and to validate the instances of a family of topic maps against that set of rules. In an example, the network creator defines topics that play a specific role in a specific association in the CKSNet knowledge model and the system will only allow those topics for that kind of association role. In another example, the set of rules is used to validate and avoid incorrect information in the CKSNet knowledge base.

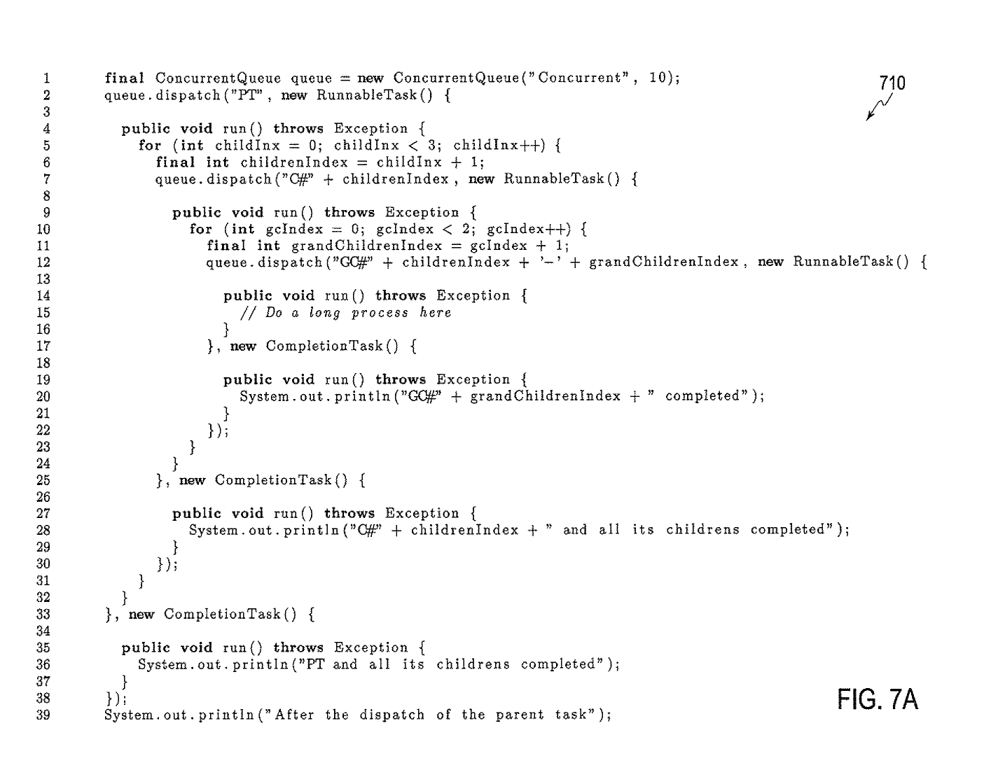

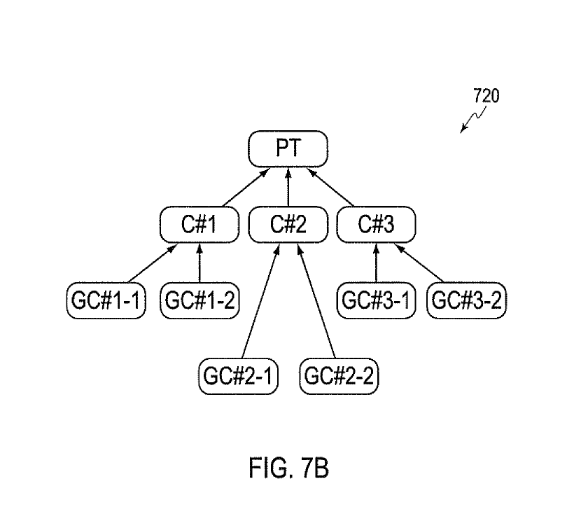

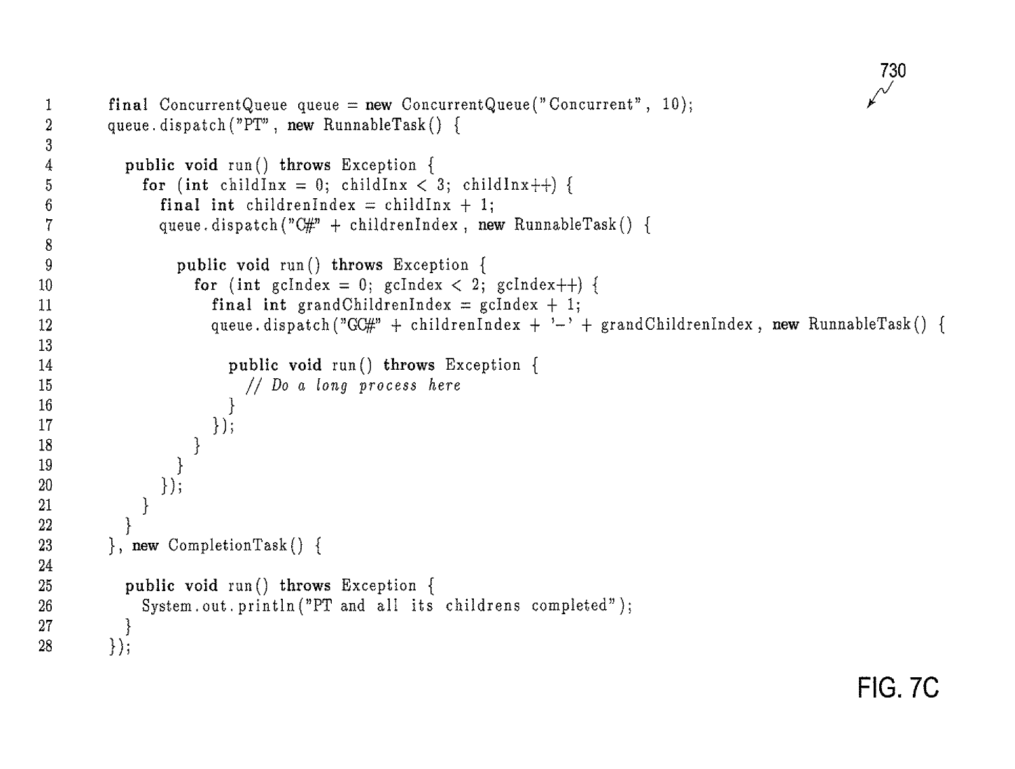

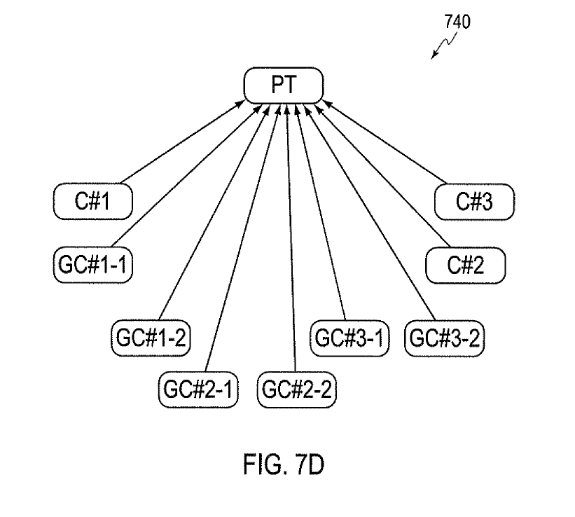

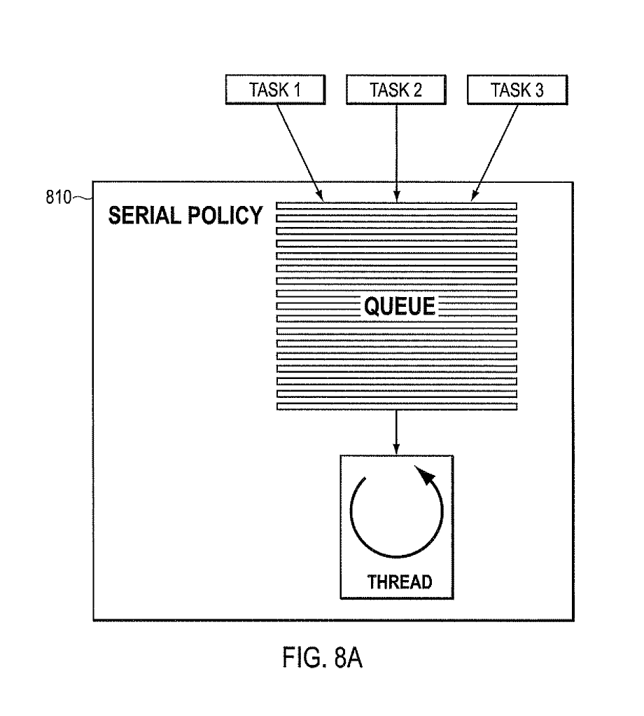

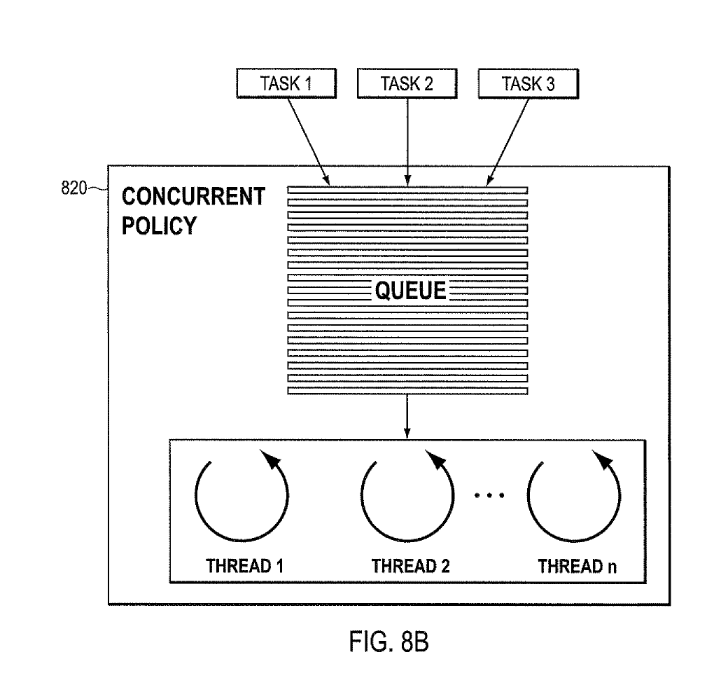

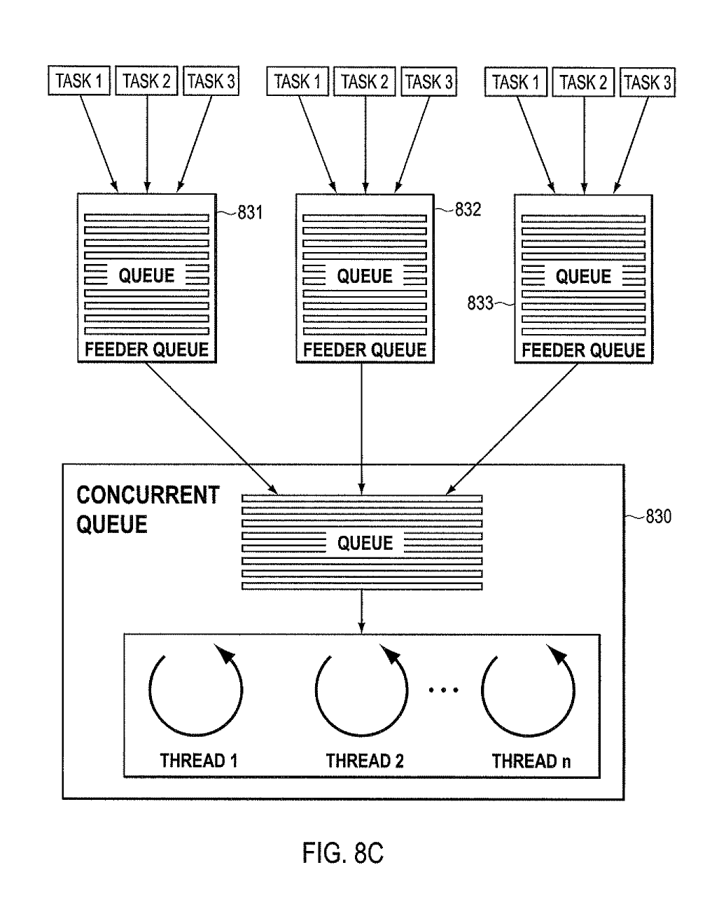

According to an embodiment of the disclosure, the semantic engine 320 includes a high concurrency development framework configured to access the topic map with high concurrency. In an embodiment, the high concurrency development framework utilizes task based programming and queue programming for increasing concurrency in a semantic engine. The task based programming and queue programming are described with regard to FIGS. 7A-7D and FIGS. 8A-8C.

Further, in an embodiment, the semantic development platform 300 includes framework components that can be reused to build applications based on the semantic engine 320. In an example, the semantic development platform 300 includes a user interface framework 310, an integration framework 330 and a managing framework 340.

The user interface framework 310 can include a set of user interface components configured to generate Web 3.0 based user interfaces for applications. According to an embodiment of the disclosure, the set of user interface components is independent of application, and can be used in any suitable application. Further, according to an embodiment of the disclosure, the user interface framework 310 can be configured to perform as a template engine to dynamically render web page contents, such as HTML or XML contents.

Further, the user interface framework 310 can include a GUI script language that binds elements of an application and the topic map together. The GUI script language provides a dialect to navigate and access a topic map. The GUI script language can bind the high concurrency development framework to navigate and access the topic map with high concurrency. In an example, an application uses the GUI script language to query the topic map, and then the result of the query can be presented in a web page table of the application.

The integration framework 330 can include a set of adapters that can be used to integrate a system based on the semantic technology with other systems. In an exemplary embodiment, the integration framework 330 includes a database-to-topic-map adaptor configured to convert information in a database to occurrences of concepts in a topic map. In another example, the integration framework 330 includes a XML to topic map adaptor configured to convert XML elements to occurrences of concepts in a topic map. In another example, the integration framework 330 includes a web services adaptor configured to convert elements of a third-party application to occurrences of concepts in a topic map. In another example, the integration framework 330 includes a Semantic Web adaptor configured to convert topic map semantic constructs to Resource Description Framework (RDF) semantic constructs to interact with Web 3.0 sites implemented with the World Wide Web Consortium (W3C) Semantic Web standard.

The managing framework 340 can include tools for operative, administration and maintenance purpose. In an example, the managing framework 340 includes tools to facilitate logging functions that keep track of events in the CKSNet. In another example, the managing framework 340 includes tools to facilitate installation functions that install suitable software pieces on the network creator devices 130 and the network member devices 120.

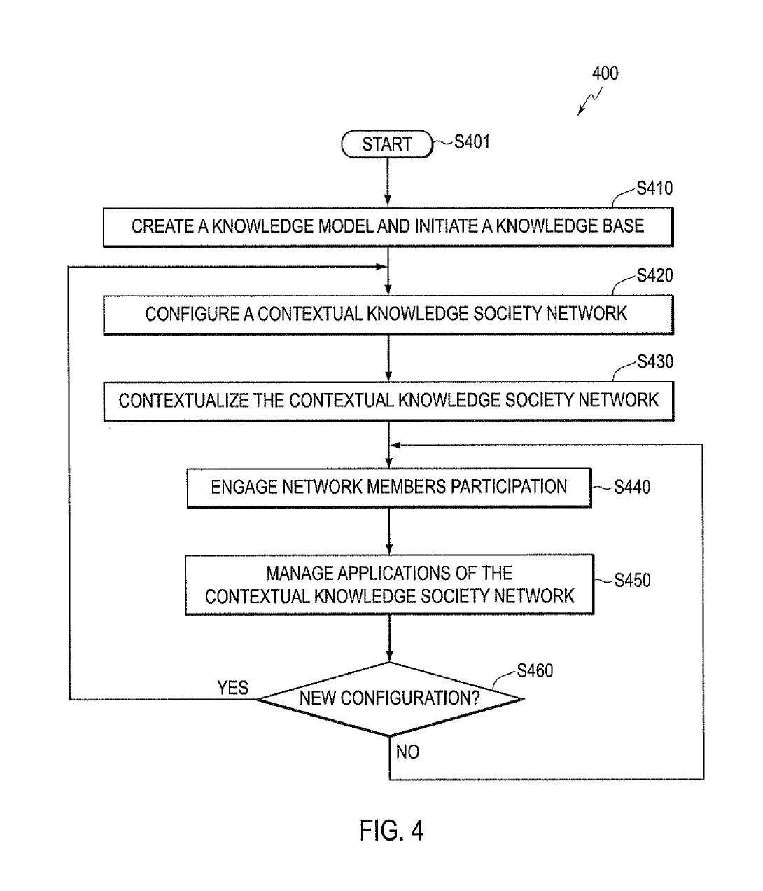

FIG. 4 shows a flow chart outlining a process example for a network creator 160 to use the semantic development platform 300 to create and manage a CKSNet according to an embodiment of the disclosure. The process starts at S401 and proceeds to S410.

At S410, based on the semantic development platform 300, a person or an entity interested in a specific context creates a knowledge model, publishes a Web 3.0 site and initiates a knowledge base. In an example, the person accesses the Web 3.0 site, joins the service provided by the knowledge network service provider 160, and becomes a network creator. Then, the knowledge network service provider 160 assists the network creator or provides tools to the network creator to create the CKSNet of the specific context based on the semantic development platform 360, and assists the network creator to manage the CKSNet based on the semantic development platform 300. In another example, the knowledge network service provider 160 assists the network creator or provides tools to the network creator to extend and manage the knowledge model of the CKSNet. In another example, the user interface framework 310 and the integration framework 330 support the network creator to present new applications on the CKSNet of the specific context by himself.

In an embodiment, the knowledge society service provider 160 assists the network creator to initiate an instance of a CKSNet based on the semantic development platform 300, such that the CKSNet is suitably coupled to the various parts, such as a semantic engine, a database, a portal, and the like of the knowledge society service provider 160. In an example, the CKSNet is initialized with a basic knowledge model, and a knowledge base instance built on the basic knowledge model.

At S420, based on the semantic development platform 300, the network creator configures attributes of the CKSNet, such as community information, web pages, appearance, privacy and security, media integration, applications, and the like based on the semantic development platform 300. In an example, the network creator configures the attributes by himself. In another example, the knowledge society service provider 160 configures the attributes according to requests from the network creator.

At S430, based on the semantic development platform 300, the network creator contextualizes the CKSNet. In an example, the knowledge society service provider 160 assists the network creator to contextualize the CKSNet according to the specific context. In another example, the network creator contextualizes the CKSNet by himself. In an embodiment, the network creator expands the knowledge model according to the specific context. In an example, the network creator adds member profile extended model to the knowledge model. In another example, the network creator adds members relationship extended model on the knowledge model. In another example, the network creator adds domain-specific knowledge network extended model to the knowledge model.

At S440, the knowledge network service provider 160 assists the network creator to engage network members to participate in the CKSNet based on the semantic development platform 300. In an embodiment, based on the semantic development platform 300, the network creator can publish web content, broadcast message, generate advertisements, alerts and recommendation, aggregate information from social media, and the like. In an example, a network member joins the CKSNet in response to a broadcast message. In another embodiment, the network creator and network members can invite other people to join the CKSNet by defining email addresses or importing contact information from online address books such as Facebook, Yahoo, Google, MSN, AOL and the like, or importing standard formats such as .csv, vCard and the like, automatically and securely sending and validating electronic invitations through email.

When the network member joins the CKSNet, the network member provides information according to, for example, a questionnaire on a webpage generated by the network creator based on the semantic development platform 300. Then, based on the provided information, a member instance is created according to the knowledge model and is suitably added into the knowledge base.

At S450, the knowledge network service provider 160 assists the network creator to manage the CKSNet. In an example, the network creator can manage applications based on the CKSNet, such as adding new features, generating new applications and the like. In another example, the network creator can perform member administrations, such as assign control right, block access, and the like. In another example, the network creator can perform analytics of the CKSNet by applying semantic processes to the CKSNet knowledge base.

It is noted that the network creator may generate applications from various business concepts based on the same knowledge base. For example, the network creator can query the knowledge base of an attribute and generate lists of the attribute. In another example, the network creator can constrain the knowledge base, and generate a subset of the knowledge base. The subset can be visualized to the network creator. In another example, the network creator may take smart actions based on the knowledge base. For example, based on the knowledge base, the network creator can generate message, recommendation, alerts, and promotional advertisement to portions of the network members that comply with a constraint.

At S460, the network creator determines to add a new configuration based on the population of the knowledge base. When a new configuration is determined, the process returns to S420; otherwise, the process returns to S440.

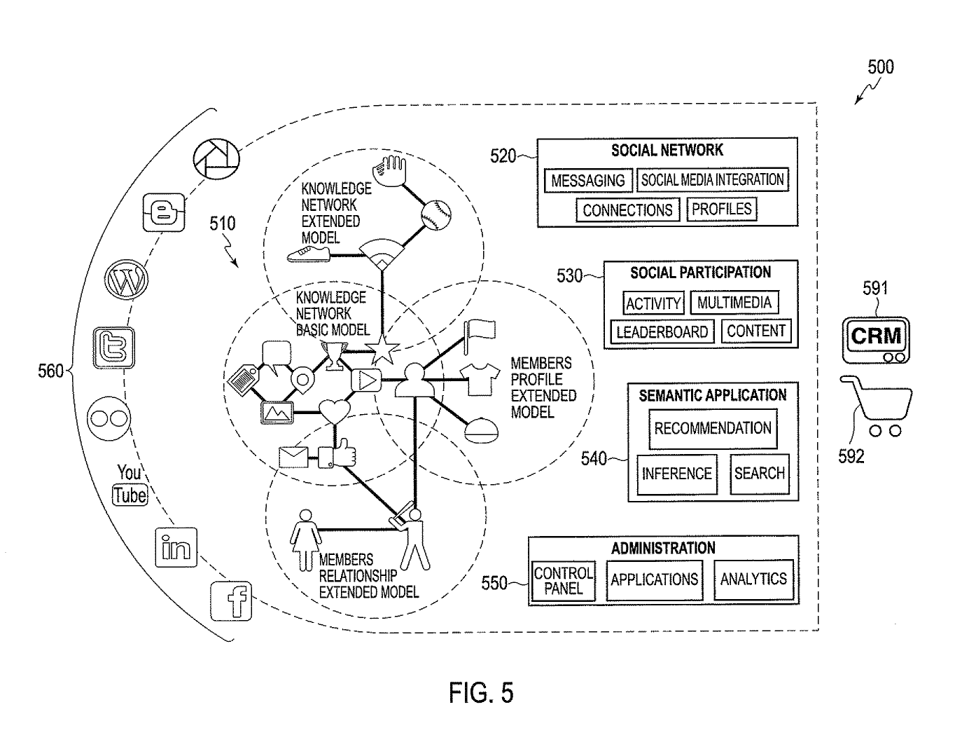

FIG. 5 shows an exemplary diagram of CKSNet architecture 500 according to an embodiment of the disclosure. The CKSNet architecture 500 includes a knowledge model 510. The knowledge model 510 includes a basic model, a member profile extended model, a members relationship extended model, and a knowledge network extended model.

Further, the CKSNet architecture 500 integrates social networks, such as messaging, social media, and the like. With the operation of the social networks, the CKSNet architecture 500 engages social participations. The participation populates a knowledge base based on the knowledge model 510.

Further, the CKSNet architecture 500 includes a semantic engine that performs semantic operations on the knowledge base. Additionally, the CKSNet architecture 500 includes administration tools that manage the CKSNet.

In an embodiment, the CKSNet architecture 500 may also integrate, customer relationship management (CRM) systems, electronic commerce systems, and the like in the architecture using the CKSNet integration framework to enable the network creator 160 to link elements of these systems to instances of the knowledge model in order to support applications such as knowledge marketing, knowledge commerce, knowledge gamification and the like.

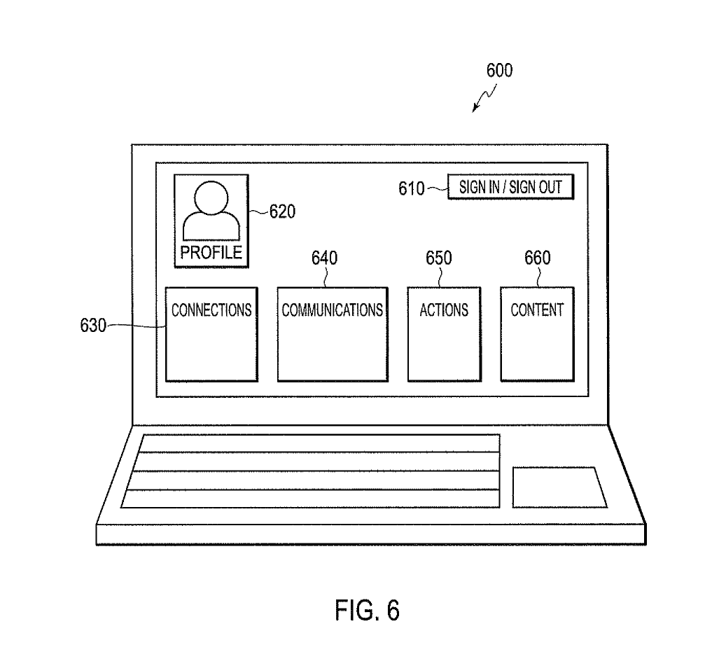

FIG. 6 shows a plot of a network member device 600 according to an embodiment of the disclosure. The network member device 600 includes a screen to display, for example, a web page of activities that a network member can participate in a CKSNet. The network member can sign in and sign out of the CKSNet. The network member needs an account with the knowledge network service provider 160 and a CKSNet identification to participate in a CKSNet. The network member can also provide profiles in the CKSNet. For example, the network member can personalize his/her profile page, member settings, account settings, privacy setting, notification settings, and social media account links.

Further, in an example, the network member can connect to the CKSNet to perform semantic operations, such as query and browse the CKSNet, make connections, generate smart lists, and the like. The network member can perform communication based on the CKSNet. For example, the network member can send message to message board, check status of a message board, send private message, post social medium, and the like, directing his communication to target audiences. The network member can perform various actions, such as comment, share, tag, rate, and the like based on the CKSNet. Further, in an example, the network member can publish and share web contents with target audiences through the CKSNet. For example, a network member who had suffered a certain kind of injury playing baseball can share multimedia, aggregate multimedia, generate alerts and recommendations, and the like regarding injury prevention, treatment, physical therapy, doctors specialized in that kind of injury, surgery options, recommended drugs for that kind of injury, and the like. The network creator can define rules for semantic inference and recommendations so certain profile of CKSNet members who have had similar injuries or have a potential risk to suffer the same kind of injury based on age, position played, prior injuries, weight, and other characteristics of the like have direct access to this knowledge.

FIGS. 7A-7D show examples of task based programming platform for increasing concurrency in a semantic development framework according to an embodiment of the disclosure.

According to an embodiment of the disclosure, a task block is a portion of code instructions that can be executed by a processor without waiting for data from other software components or services. The task block can be scheduled to execute in a processing queue. In an example, a task block in Java is typically, but not necessarily, formed using a closure-like construct. For example, the task block includes a “run” method in which the programmer implements the intended logic of application.

As the application executes, a running task may spawn more sub-tasks to implement the application logic. The task based programming platform en-queues the sub-tasks in the appropriate processing queues. The sub-tasks can be scheduled asynchronously with respect to the parent task. The task based programming platform maintains a hierarchy of tasks that have completed in a task tree where each parent keeps a list of sub-tasks. Once a sub-task is completed, the sub-task is removed from its parent.

FIG. 7A shows code instructions example 710 according to an embodiment of the disclosure; and FIG. 7B shows a task tree 720 of three level task hierarchy generated according to the code instructions 710 according to an embodiment of the disclosure.

Specifically, at the top of the hierarchy, a parent task (PT) is created and scheduled for execution in line #2. Once, task PT is executed, the task PT creates and schedules for execution three sub-tasks C#1, C#2 and C#3 in line #7. Further, when each of the three sub-tasks is executed, the sub-task creates and schedules grandchild tasks, such as GC#1-1, GC#1-2, GC#2-1, GC#2-2, GC#3-1, and GC#3-2.

It is noted that each task scheduled for execution using the “dispatch” method can run asynchronously from others. It is noted that in line #1, ten concurrent queues are created to have a capacity to execute ten tasks at a time, Further, it is noted that order of the task execution is not deterministic. For example, line #39 may be executed before or after line #5, and task GC#1-1 may be executed before or after C#3.

Further, the task based programming platform provides other optional task blocks of specific logic that a programmer can choose to use, such as a completion task, an exception hander, a finally task, and the like.

In an embodiment, a completion task is invoked when all the descendent tasks, such as sub-tasks, grandchild tasks, and the like finish their execution and no exception is reported in any of them. An exception handler is invoked once all the descendent tasks have finished their execution, and at least one of them has reported an exception. The exception handler receives a list of exceptions reported by the sub-tasks. The finally task is invoked once all the descendant tasks have finished their execution, no matter whether there are exceptions reported or not. The final task is invoked after either one of the completion tasks or the exception hander has been executed.

According to an aspect of the disclosure, the order of execution of an entire task block is as follows:

(i) Execute the task block;

(ii) Apply the same algorithm to all the subtasks and wait for the last one to complete;

(iii) If there was any uncaught exception and the programmer provided an exception handler, execute the exception handler;

(iv) If there is no uncaught exception and the programmer provides a completion task, execute the completion task;

(v) If the programmer provides a finally task, execute the finally task.

It is noted that the wait in step (ii) does not block the execution thread. Information is maintained in the run time so when the last sub-task is completed, the next block for this task is executed. It is noted that, in an example, there is no relation between the task hierarchy and the queues used to execute each task.

According to an embodiment of the disclosure, task hierarchy can be optimized to improve performance and memory usage. In an example, some times, a task does not need to wait for completion of sub-tasks. A logging task does not need to wait for log entry being generated. The logging task can schedule the log entry and continue with its job.

According to an embodiment of the disclosure, when completion task is not needed, code instructions can be optimized, and a task is associated with a closest task that has one of the optional task blocks.

FIG. 7C shows code instructions 730 that are optimized from code instructions 710. In the code instructions 730, sub-tasks C#n can be scheduled without completion task. FIG. 7D shows a task tree 740 of two level task hierarchy generated according to the code instructions 730 according to an embodiment of the disclosure. The sub-tasks C#n can be terminated and release their data structures before grandchild GC#n tasks are completed. The task tree 740 has higher concurrency than the task tree 720.

FIGS. 8A-8C show examples of processing queues for increasing concurrency in a semantic development framework according to an embodiment of the disclosure.

The high concurrency development framework provides queues applying various policies. The queues can be suitably selected to handle tasks of different needs.

FIG. 8A shows a queue and execution unit 810 applying a serial policy. The queue and execution unit 810 has a capacity of one, which means the queue and execution unit 810 executes one task at a time. The queue and execution unit 810 with the serial policy can be used to handle critical tasks without having to block threads. A task is not completed until the task block and all the optional blocks have been executed. When a sub-task tries to en-queue a new task in the queue, a deadlock occurs.

FIG. 8B shows a queue and execution unit 820 applying a concurrent policy. The queue and execution unit 820 has multiple execution units and has a capacity of n, which means the queue and execution unit 820 processes n tasks at a time. The queue and execution unit 820 with concurrent policy can be used to process tasks that do not need to wait for completion of each other.

FIG. 8C shows a feeder queue arrangement according to an embodiment of the disclosure. The feeder queue arrangement in FIG. 8C includes feeder queues 831-833 and a queue and execution unit 830 applying a concurrent policy. The feeder queues 831-833 are FIFO queues and are configured to queue tasks serially. The queue and execution unit 830 is a concurrent queue that handles tasks from the feeder queues 831-833 concurrently. Generally, the feeder queues 831-833 use reduced system resources. The feeder queue arrangement in FIG. 8C is configured to handle critical tasks in series, and handle other tasks concurrently with reduced system resources, such as reduced memory space, and the like.

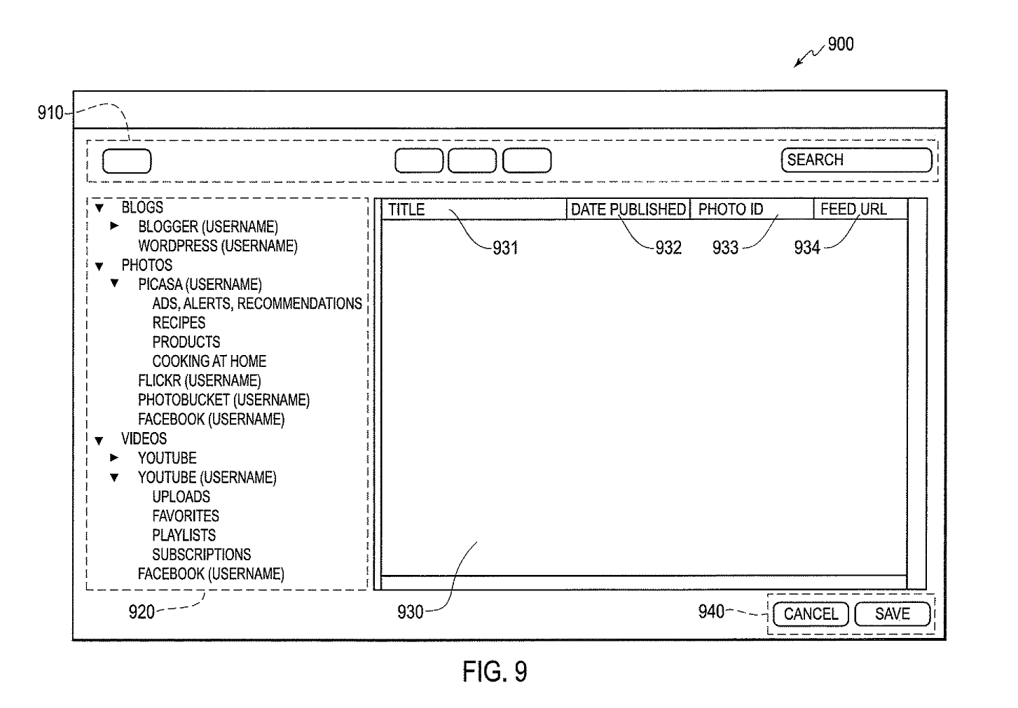

FIG. 9 shows a plot of a graphical user interface example 900 of a “Navigable Web Content Finder” application according to an embodiment of the disclosure. According to an embodiment of the disclosure, “Navigable Web Content Finder” is a Web application that provides a user interface to access content managed and stored in different sites or services, exposed through an API on the Web or what is known as “the cloud” (typically using a REST architecture). With “Navigable Web Content Finder”, a network member can add different Web content providers such as YouTube, Flickr, Blogger, Facebook, and the like. When the network member runs an aggregation process, the network member authorizes “Navigable Web Content Finder” as a reliable source in various content and social media sites. Further, “Navigable Web Content Finder” provides a user interface, such as the graphical user interface 900, to facilitate the network member to access, visualize, aggregate, and manage the contents at the various content sites and social media. Via the user interface, the network member can also integrate the contents as instances of the CKSNet knowledge base under a specific context.

In the FIG. 9 example, the user interface 900 includes a tool bar portion 910, a container tree portion 920, a content portion 930, and an action portion 940. The tool bar portion 910 includes tools that can be used in “Navigable Web Content Finder”, such as a search tool, a customization tool, and the like.

The container tree portion 920 visualizes content providers and containers of the content providers in a tree structure. The network member can add new provider in the tree structure, view container lists of a provider, and the like.

The content portion 930 visualizes contents in a container, such as list of files, picture thumbnails, and the like. In the FIG. 9 example, the content portion 930 visualizes a list of files. The content portion 930 also includes attribute fields for the files, such as a title field 931, a publish date field 932, a photo ID field 933 and a URL field 934.

The action portion 940 enables a network member to take suitable actions on the contents. For example, the network member can select media content that resides in the other content providers and save in a knowledge base of a CKSNet.

According to an aspect of the disclosure, “Navigable Web Content Finder” maintains an organized container tree 920 based on different types of content such as blogs, photos, videos, bookmarks, and the like and according to various source services in which the user maintains one or more linked accounts such as Blogger, Flicker, YouTube, Facebook, Delicious, and the like. Depending on the service or social media content, there may be public accounts to visualize content that are not necessarily owned by the user. “Navigable Web Content Finder” can add this type of content without an authentication process, as long as the content is public content and the service does not have security restrictions (e.g., a YouTube public channel).

Further, the user interface 900 can be used to access private content. In an example, “Navigable Web Content Finder” provides authentication tools to be approved as a reliable source on third party sites and to enable the communication required for the virtual aggregation of content. Once authenticated, the user can select the content they want to add in “Navigable Web Content Finder” through the native APIs provided by third-party services such as Google Data Google, Open Graph of Facebook, and the like. According to an embodiment of the disclosure, “Navigable Web Content Finder” manages participation in various social media site accounts without having to authenticate separately in each one of these sites every time the network member wants to access specific content of interest. The network member is required to register once in order to authorize future access under the concept of a reliable source.

In addition, each content or social media service can organize content in a particular way. “Navigable Web Content Finder” may represent photo albums, lists of videos or a container for playlists or subscriptions, based on these mechanisms of organization. The types of content containers vary depending on the different services. For example, YouTube videos can be organized and visualized by file downloads, favorites, playlists and subscriptions. File downloads and favorites represent video containers but playlists and subscriptions represent containers of video containers, for example.

Further, “Navigable Web Content Finder” knows the different types of containers and content topics and, depending on the type, “Navigable Web Content Finder” knows what information and how to display it. For example, when a user clicks on any container in the tree, “Navigable Web Content Finder” displays the list of content topics included in the respective container. The list of content topics appears as a table or a grid showing metadata about topics such as title, date created, date of aggregation, URL, and the like. The different types of content entities can be videos, photos, songs, blogs, podcasts, news, maps, bookmarks, and the like.

“Navigable Web Content Finder” offers an integrated environment for providing a comprehensive capability to navigate, view and select related contents scattered in various Web sites from a single page; eliminating the need for duplication of information and expensive storage resources, keeping information current as long as the virtual identity reference of the content entity does not change on the original source; managing participation in various social media site accounts without having to authenticate separately in each one of these sites every time the user wants to access specific content of interest; extracting and delivering content metadata of interest so that other applications can reuse it; providing centralized search applied globally to all contents; and reusing external content by other applications.

While the invention has been described in conjunction with the specific embodiments thereof that are proposed as examples, it is evident that many alternatives, modifications, and variations will be apparent to those skilled in the art. Accordingly, embodiments of the invention as set forth herein are intended to be illustrative, not limiting. There are changes that may be made without departing from the scope of the invention.

What is claimed is:

1. A CKSNet system, comprising:
a knowledge model configured to represent a knowledge society entity with a specific context;
a semantic engine; and
a plurality of processors configured to implement software instructions that instruct the semantic engine to operate a CKSNet according to the knowledge model.

2. The CKSNet system of claim 1, wherein the processors generate a graphical user interface that is configured to enable a network creator of the CKSNet to modify the knowledge model using the semantic engine.

3. The CKSNet system of claim 1, wherein the processors generate a graphical user interface that is configured to enable network members of the CKSNet to cause the semantic engine to access the CKSNet, populate instances of concepts in the CKSNet, and/or extract specific knowledge from CKSNet.

4. The CKSNet system of claim 1, wherein the processors are configured to process a plurality of access operations to a knowledge base of the CKSNet in a single semantic transaction.

5. The CKSNet system of claim 4, wherein the processors are configured to process a plurality of semantic transactions concurrently.

6. The CKSNet system of claim 1, wherein the processors are configured to generate a graphical user interface that is configured to navigate, view and select contents in a plurality of web sites.

7. The CKSNet system of claim 1, wherein the knowledge model is configured to semantically represent elements and links of the elements under the specific context.

8. The CKSNet system of claim 1, comprising:
a first memory configured to store a knowledge base of the CKSNet according to the knowledge model; and
a second memory configured to store information for generating the knowledge base.

9. The CKSNet system of claim 8, wherein the second memory is non-volatile memory.

10. The CKSNet system of claim 1, wherein the semantic engine is configured to operate on a topic map of the CKSNet generated based on the knowledge model.

11. A method of providing a CKSNet, comprising:
determining a knowledge model to represent a knowledge society entity with a specific context;
utilizing a semantic engine to create a CKSNet according to the knowledge model; and
utilizing the semantic engine to manage the CKSNet according to the knowledge model.

12. The method of claim 11, further comprising:
providing a graphical user interface that enables a network creator of the CKSNet to define and update the knowledge model using the semantic engine.

13. The method of claim 11, further comprising:
providing a graphical user interface that enables network members of the CKSNet to cause the semantic engine to access the CKSNet, populate instances of concepts in the CKSNet and/or extract specific knowledge from the CKSNet.

14. The method of claim 11, further comprising:
providing a graphical user interface that is configured to navigate, view and select contents in a plurality of web sites.

15. The method of claim 11, further comprising:
using the semantic engine to process a plurality of access operations to a knowledge base of the CKSNet in a single transaction.

16. The method of claim 15, further comprising:
using the semantic engine to process a plurality of transactions concurrently.

17. The method of claim 11, wherein determining the knowledge model to represent the knowledge society entity with the specific context further comprises:
semantically representing elements and links of the elements under the specific context.

18. The method of claim 11, further comprising:
storing a knowledge base of the CKSNet according to the knowledge model.

19. The method of claim 11, further comprising:
storing information for re-generating the knowledge base in a non-volatile memory.

20. The method of claim 11, further comprising:
utilizing a semantic engine to operate on a topic map of the CKSNet generated based on the knowledge model.

21. A non-transitory storage medium storing program instructions for causing a processor to execute operations for providing a CKSNet, the operations comprising:
determining a knowledge model to represent a knowledge society entity with a specific context;
utilizing a semantic engine to create a CKSNet according to the knowledge model; and
utilizing the semantic engine to manage the CKSNet according to the knowledge model.

22. The non-transitory storage medium of claim 21, wherein the operations further comprise:
providing a graphical user interface that enables a network creator of the CKSNet to modify the knowledge model using the semantic engine.

23. The non-transitory storage medium of claim 21, wherein the operations further comprise:
providing a graphical user interface that enables network members of the CKSNet to cause the semantic engine to access the CKSNet, populate instances of concepts in the CKSNet, and/or extract specific knowledge from the CKSNet.

24. The non-transitory storage medium of claim 21, wherein the operations further comprises:
providing a graphical user interface that is configured to navigate, view and select contents in a plurality of web sites.

25. The non-transitory storage medium of claim 21, wherein the operations further comprise:
using the semantic engine to process transactions with concurrency.

26. The non-transitory storage medium of claim 21, wherein the operations further comprise:
using the semantic engine to process transactions semantically.

27. The non-transitory storage medium of claim 21, wherein determining the knowledge model to represent the knowledge society entity with the specific context further comprises:
semantically representing elements and links of the elements under the specific context.

28. The non-transitory storage medium of claim 21, wherein the operations further comprise:
storing a knowledge base of the CKSNet according to the knowledge model.

29. The non-transitory storage medium of claim 21, wherein the operations further comprise:
storing information for re-generating the knowledge base in a non-volatile memory.

30. The non-transitory storage medium of claim 21, wherein the operations further comprise:
utilizing a semantic engine to operate on the knowledge model in the form of a topic map.
